(19) United States
(12) Patent Application Publication
(10) Pub. No.: US 2025/0273763 A1
(43) Pub. Date: Aug. 28, 2025

(54) BATTERY PACK, BATTERY SYSTEM AND SPACER FOR BATTERY SYSTEM

(71) Applicant: SAMSUNG SDI CO., LTD., Yongin-si (KR)

(72) Inventor: Eymen IPEK, Graz (AT)

(21) Appl. No.: 18/798,535

(22) Filed: Aug. 8, 2024

(30) Foreign Application Priority Data
Feb. 22, 2024 (EP) 24159160.1

(51) Int. Cl. H01M 10/6555; H01M 10/613; H01M 10/647; H01M 10/653; H01M 10/658; H01M 50/209; H01M 50/291; H01M 50/293

(52) U.S. Cl. CPC H01M 10/6555; H01M 10/613; H01M 10/647; H01M 10/653; H01M 10/658; H01M 50/209; H01M 50/291; H01M 50/293

(57) ABSTRACT

A battery pack including: a battery cell stack including a plurality of battery cells and a spacer between two adjacent ones of battery cells; and a cooler at a bottom side of the battery cell stack. The bottom side of the battery cell stack being opposite to a venting side of the battery cell stack. The spacer includes a thermally insulating core and a heat conductive structure at a lateral surface of the spacer facing a lateral surface of one of the battery cells. The heat conductive structure includes a center element arranged centrally in the lateral surface of the spacer and trajectories extending from the center element into peripheral areas of the lateral surface of the spacer.

### CROSS-REFERENCE TO RELATED APPLICATION

The present application claims priority to and the benefit of European Patent application Ser. No. 24/159,160.1, filed on Feb. 22, 2024, in the European Patent Office, the entire disclosure of which is incorporated herein by reference.

### BACKGROUND

### 1. Field

Aspects of embodiments of the present disclosure relate to a battery pack, a battery system, and a spacer for a battery system.

### 2. Description of the Related Art

Recently, vehicles for transportation of goods and peoples have been developed that use electric power as a source for motion. Such an electric vehicle is an automobile that is propelled by an electric motor using energy stored in rechargeable (or secondary) batteries. An electric vehicle may be solely powered by batteries (a Battery Electric Vehicle or BEV) or may include a combination of an electric motor and, for example, a conventional combustion engine (a Plugin Hybrid Electric Vehicle or PHEV). BEVs and PHEVs use high-capacity rechargeable batteries, which are designed to provide power for propulsion over sustained periods of time.

A single battery cell generally includes an electrode assembly including a positive electrode, a negative electrode, and a separator interposed between the positive and negative electrodes. A solid or liquid electrolyte allows for the movement of ions during charging and discharging of the battery cell. The electrode assembly is accommodated in a casing and electrode terminals, which are positioned on the outside of the casing, establish an electrically conductive connection to the electrodes. The shape of the casing may be, for example, cylindrical or rectangular.

A battery module includes a plurality of battery cells connected in series or in parallel. For example, the battery module may be formed by interconnecting the electrode terminals of the plurality of battery cells to each other in an arrangement or configuration to provide a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected in series to provide a desired voltage.

A battery pack is a set of any number of (often identical) battery modules or single battery cells. The battery modules, and respectively the battery cells, may be configured in a series, parallel, or a mixture of both to deliver the desired voltage, capacity, and/or power density. Components of a battery pack include the individual battery modules and the interconnects, which provide electrical conductivity between the battery modules.

Exothermic decomposition of cell components may lead to a so-called thermal runaway. Generally, thermal runaway refers to a process that is accelerated by increased temperature, in turn releasing energy that further increases temperature. Thermal runaway occurs in situations when an increase in temperature changes cell conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (typically above about 150° C.), the battery cell can transition into a thermal runaway. Generally, temperatures outside of a safe region, on either the low or high side, may lead to irreversible damage to the battery cell and, therefore, may possibly trigger thermal runaway. Thermal runaway may also occur due to an internal or external short circuit of the battery or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in a cell housing into the battery pack. The main components of the vented gas are H₂, CO₂, CO, electrolyte vapor, and other hydrocarbons. The vented gas is, therefore, flammable and potentially toxic. The vented gas also causes a gas-pressure increase inside the battery pack. In the worst case, the high temperatures lead to the process spreading to neighboring battery cells and fire in the battery pack. At this stage, the fire is hard to extinguish.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery pack includes: a battery cell stack including a plurality of battery cells and a spacer between two adjacent ones of the battery cells of the battery cell stack. The battery pack further includes a cooler at a bottom side of the battery cell stack, which is opposite to a venting side of the battery cell stack. The spacer includes a thermally insulating core and a heat conductive structure arranged at a lateral surface of the spacer facing a lateral surface of one of the battery cells. The heat conductive structure includes a center element arranged centrally in the lateral surface of the spacer and trajectories extending from the center element into a peripheral area of the lateral surface of the spacer.

According to another embodiment of the present disclosure, a battery system includes the battery pack as described above.

According to another embodiment of the present disclosure, a spacer for a battery pack. The spacer includes a thermally insulating core and a heat conductive structure arranged at a lateral surface of the spacer. The heat conductive structure includes a center element arranged at an upper half of the lateral surface of the spacer and trajectories extending from the center element into a peripheral area of the spacer.

According to another embodiment of the present disclosure, a method for transferring heat within a battery system includes: providing the battery system as described above; separating the battery cells of the battery cell stack from each other by positioning a spacer between two adjacent ones of the battery cells such that a first lateral surface of the spacer contacts a first lateral surface of a first one of the battery cells and a second lateral surface of the spacer, opposite of the first lateral surface of the spacer, contacts a second lateral surface of a second one of the battery cells of the battery cell stack; and transferring heat from a heated up battery cell of the battery cell stack via the spacer. The heat is transferred from a hotspot of the battery cell to a peripheral area of the spacer such that a critical temperature, which may lead to thermal runaway of a battery cell adjacent to the spacer, is not exceeded.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic cross-sectional view of a battery system according to an embodiment of the present disclosure.

FIG. 2 is a perspective view of a spacer according to an embodiment of the present disclosure.

FIG. 3 is a perspective view of a spacer according to another embodiment of the present disclosure.

FIG. 4 is a top view of a spacer according to another embodiment of the present disclosure.

FIG. 5 is a flowchart describing a process for transferring heat from a heated up battery cell within a battery pack according to an embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the embodiments shown in the accompanying drawings. The present disclosure may, however, be embodied in various different forms and should not be construed as being limited to the embodiments illustrated herein. Rather, these embodiments are provided as examples so that this disclosure will be thorough and complete and will fully convey the aspects and features of the present disclosure to those skilled in the art. Accordingly, processes, elements, and techniques that are not considered necessary for those having ordinary skill in the art to have a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery pack includes a battery cell stack including a plurality of battery cells and at least one spacer positioned between two adjacent battery cells in the battery cell stack. The battery pack includes a cooler positioned at a bottom side of the battery cell stack and a venting side opposite to the bottom side of the battery cell stack. The spacer includes a thermally insulating core and at least one heat conductive structure arranged on or near a lateral surface of the spacer facing a lateral surface of the battery cell. The heat conductive structure includes a center element arranged in the lateral surface of the spacer and trajectories (or projections) that extend from the center element into peripheral areas of the lateral surface of the spacer.

Embodiments of the present disclosure are directed to a battery pack including a plurality of battery cells and at least one spacer. In some embodiments, for example, a plurality of spacers are alternately arranged with the battery cells within the battery pack. The battery pack includes a cooler connected to (or arranged at) a cooling side of the battery pack and a vent on a venting side opposite to the cooling side of the battery pack. The spacer is arranged between adjacent ones of the battery cells to thermally insulate the battery cells and to prevent a thermal runaway of the battery pack. Each spacer from among the plurality of spacers includes a thermally insulating core and at least one heat conductive structure. The heat conductive structure is arranged on a lateral surface of the spacer facing towards a lateral surface of the battery cell to transfer heat from the battery cell. The heat conductive structure is configured to transfer heat to the peripheral area(s) of the spacer and, thus, may be referred to as a heat transferring structure. The heat conductive structure includes a center element, or central spot/area, and trajectories (e.g., arms, rays, or projections) extending from the center element into the peripheral area of the spacer to transfer heat generated by an affected battery cell to the peripheral areas of the spacer, therefore reducing the heating of adjacent battery cells to prevent the battery pack from a thermal runaway.

A spacer is an element that separates two adjacent battery cells and thermally disconnects the two adjacent battery cells from each other so that heat transfer between the two adjacent battery cells is reduced or minimized. A heat conductive structure is a structure made of a material with a relatively high thermal conductivity and may include, for example, silver, copper, aluminum, iron, and other metals.

A thermally insulating core is a core made of a material with a relatively very low thermal conductivity and may include, for example, a polymer material, a foam, or other insulating materials.

A cooler is a structure that is designed to lead a cooling fluid, such as water, to (or around) a housing of a battery cell to cool down the battery cells and to transfer heat from the battery cell towards other areas of a battery system. A venting side is a side of the battery cells from which pressure may be relieved in the event that there is a pressure increase inside the battery cell beyond a certain threshold value beyond which a further pressure increase would lead to a dangerous deformation of the battery cell.

The heat conductive structure being on a lateral surface of the spacers means that the heat conductive structure is in direct contact with a lateral surface of the battery cell when the spacer is inserted into the battery cell stack, that is, in an assembled stated of the battery cell stack or battery pack. The heat conductive structure being near the surface means that the heat conductive structure may be fully or partly embedded in the thermal insulating material of the core of the spacer. In some embodiments, the heat conductive structure is a maximum of about 10%, and in some embodiments is a maximum of about 5%, in extent of the spacer away from the lateral surfaces of the spacer.

The heat conductive structure of the spacer conducts heat from a heated battery cell, for example, in case of a malfunction of a battery cell, so that the thermal impact to the immediately adjacent battery cells of the heated battery cell is reduced or minimized. This prevents the entire battery cell stack from a thermal runaway and a chain reaction that could lead to a burn down of the battery system. By transferring the heat to regions of the spacer not directly adjected to a heat hotspot at a lateral surface of the affected battery cell, a thermal runaway can be prevented so that only the heated battery cell experiencing the malfunction is affected. This not only improves the safety of the battery cell but also makes it possible and cost effective to repair a battery system by simple changing the one affected battery cell. The trajectories allow for reduced weight in comparison to a standard metal plate so that the weight of the spacer may be reduced. Furthermore, the trajectories allow for thermal conduction to areas of the spacer and the battery pack at where the heat can be better and most easily dissipated so that the risk of a thermal runaway can be reduced. Further, the heat capacity of the heat conductive element can be reduced in comparison to a metal plate such that the structure heats up und cools down more quickly.

According to an embodiment of the present disclosure, the spacer includes two heat conductive structures arranged at (e.g., on or near) opposite lateral surfaces of the spacer. For example, one of the two heat conductive structures may be arranged on a first lateral surface of the spacer facing a first battery cell from among the two adjacent battery cells, and the other one of the two heat conductive structures may be arranged on a second lateral surface of the spacer facing a second battery cell from among the two adjacent battery cells. The two heat conductive structures allow for a more even heating/warm up of the spacer and better heat transfer to the peripheral regions of the spacer, irrespective of which one of the two adjacent battery cells contacting the spacer is heated up, so that a thermal runaway is disrupted in both ways.

In an embodiment, the heat conductive structure is distanced from (e.g., is spaced from) the venting side by at least about 10% of the distance from the cooling side to the venting side. This allows for better transport of heat from a hotpot of a malfunctioning battery cell so that the heat transferred via the spacer to an adjected battery cell is reduced or minimized. Spacers without heat conductive structures can only slow heat transfer. The heat conductive structure, according to embodiments of the present disclosure, can transfer the heat from the hot spot to cooler regions of the spacer so that the spacer heats up more evenly and less heat is transferred to the adjacent battery cell.

According to an embodiment of the present disclosure, the heat conductive structure has a thermal conductivity that is at least about one hundred times, and in some embodiments, at least about five hundred times or at least one about thousand times higher, than the thermal conductivity of the thermally insulating core. The higher thermal conductivity of the heat conductive structure leads to a more even warm up of the spacer and better heat transfer to the peripheral regions of the spacer so that more heat can be transferred to the cooler and the heat up of the adjected battery cell is further impeded.

In an embodiment, the heat conductive structure is made of metal or includes metal, for example, a metal composite, for the heat distribution within the spacer. While the core of the spacer may be made of a material with relatively low thermal conductivity, such as a polymer, the heat conductive structure made of metal has a significantly higher thermal conductivity compared to plastic components so that heat can be better conducted to the edge areas of the spacer and more uniform heating of the spacer is achieved. This prevents or at least reduces the risk of hot spots in the spacer and spillover to an adjacent battery cell.

The metal may be, for example, aluminum or copper. Aluminum and copper not only have relatively high thermal conductivity but also can be easily processed and formed to form thermally conductive components.

According to an embodiment of the present disclosure, the heat conductive structure is a stamped or fine blanked metal plate of a relatively high thermal conductive material or includes such a stamped plate. Stamped metal plates on the surface of the spacer or embedded in the edge area of the spacer can transfer heat from a hotspot of an affected battery cell contacting the spacer and, therefore, leads to even heating of the spacer.

According to another embodiment of the present disclosure, the heat conductive structure includes a thermally highly conductive center element and thermally highly conductive trajectories extending from the center element into the peripheral area(s) of the spacer. A first set of trajectories extends from the center element into the upper peripheral area of the spacer, and a second set of trajectories extends from the center element into the lower peripheral area of the spacer. Such parts can reduce weight and decrease the thermal capacity of the heat conductive structure, such that the spacer is heated up more evenly and the heat is transferred from a heat hotspot at a lateral surface of the battery cell so that the adjacent battery is less affected by such a heat hotspot. Furthermore, such parts can easily be produced as stamped parts. The trajectories can define thermal distribution leads and transfer heat along the trajectories.

In an embodiment of the present disclosure, the heat conductive structure has a star structure including a center (e.g., a center element) and a plurality of trajectories extending from the center into the peripheral area of the spacer. The trajectories have the same (or equal) distance between each other. The trajectories of the star shape are good at transporting heat from the center to the peripheries of the spacer. Therefore, even heating of the spacer can be achieved, preventing adjacent battery cells from heating up beyond a critical temperature for a thermal runaway of the battery cell stack.

In another embodiment of the present disclosure, the heat conductive layers have a spider web structure in which the trajectories extend from the center element into the peripheral area of the spacer and further circular structures connecting (or extending between) the trajectories such that additional heat can be transferred along the circular structures. For example, the spider web structure includes a center and a plurality of projections/arms/rays extending from the center into the peripheral area of the spacer and further includes a plurality of circles surrounding (or extending around) the center and connecting the projections/arms/rays extending from the center to the peripheral area of the spacer. The spider web structure allows heat to be evenly dissipated from the center throughout the spacer. This prevents local overheating of the spacer due to a punctual (or localized) heat input from a defective battery cell, especially from a heat hotspot at a lateral surface of an affected battery cell.

According to an embodiment of the present disclosure, the heat conductive structure is embedded in the thermally insulating material of the thermally insulation core. Embedding the heat conductive layer can prevent damage to the heat conductive layers when mounting the battery cell stack and can prevent the trajectories from being broken or bent while mounting the spacers in the battery pack. Furthermore, the spacers can be manufactured by a simple injection molding process in which the heat distribution elements are encased by the core of the spacer and, thus, are fixed in the intended positions.

In an embodiment of the battery pack, the battery cells are prismatic battery cells. Prismatic battery cells can be easily assembled in parallel stacks so that heat can be transferred from the prismatic battery cells via the spacers. The spacer could also be used for round cells with a corresponding design so that neighboring battery cells are separated from each other by the spacer to avoid a thermal runaway of a battery pack.

According to another embodiment of the present disclosure, a battery system includes a battery pack including a housing and a plurality of battery cells and spacers arranged alternately within the housing to form a battery cell stack. The battery system further includes a cooler connected to (or arranged adjacent to) a cooling side at the bottom of the battery cell stack and a venting side opposite to the cooling side of the battery cell stack. The spacer includes a thermally insulating core and at least one heat conductive structure arranged at (e.g., on or near) lateral surfaces of the spacer facing a lateral surface of the battery cell. The heat conductive structure includes a center element arranged in an upper half of the lateral surface of the spacer and trajectories extending from the center element into a peripheral area of the lateral surface of the spacer. The trajectories, in one embodiment, extend further toward the cooling side than toward the venting side of the battery pack.

The spacer conducts the heat of a heated battery cell, such as in the case of a malfunction of a battery cell, so that the thermal impact to the immediately adjacent battery cells of the heated battery cell is reduced or minimized. This prevents the entire battery pack from a thermal runaway and a chain reaction that could lead to a burn down of the battery system. When the heat is transferred to regions of the spacer not directly adjacent to the heated battery cell, such a thermal runaway can be prevented so that only the heated battery cell with the malfunction is affected. This not only improves the safety of the battery cell but also allows for the cost effective repair of a battery system by simple changing the one affected battery cell.

According to another embodiment of the present disclosure, a spacer for a battery pack includes a thermally insulating core and at least one heat conductive structure arranged at (e.g. on or near) a lateral surface of the spacer. The heat conductive structure includes a center element arranged centrally in an upper half of the lateral surface of the spacer and trajectories extending from the center element into a peripheral area of the spacer. The spacer, according to an embodiment of the present disclosure, allows for a more even heat distribution within the spacer and for heat dissipation from a heat hotspot of an affected battery cell. This decreases the risk of a thermal runaway because the affected battery cells are heated more evenly and punctual (or localized) heat pockets, which could otherwise lead to thermal damage of the neighboring battery cells or a thermal runaway of the battery pack, are prevented.

According to an embodiment of the spacer, the spacer includes two heat conductive structures arranged on opposite lateral surfaces or embedded in the thermally insulating material of the core near opposite surfaces of the spacer. Heat conductive structures on the lateral surfaces of the spacer provide improved heat distribution when the spacer is in contact with a lateral surface of battery cell. Partly or fully embedded heat distribution structure reduces the danger of damaging one or more of the trajectories when the spacer is inserted into the battery pack. The heat conductive trajectories transport heat from the center element to the peripheries of the spacer. Therefore, even heating of the spacer can be achieved, preventing affected battery cells from heating up beyond a critical temperature beyond which a thermal runaway of the battery cell stack may occur.

According to another embodiment of the present disclosure, a method for transferring heat within a battery pack includes: providing a battery system as described above; separating the battery cells of the battery cell stack from each other by positioning a spacer between two adjacent ones of the battery cells, with a first lateral surface of the spacer contacting a first lateral surface of a first battery cell and a second lateral surface of the spacer, opposite to the first lateral surface of the spacer, contacting a second lateral surface of a second battery cell of the battery cell stack; and transferring heat from a heated battery cell of the battery cell stacks via the spacer. The heat is transferred from a hotspot of the battery cell to a peripheral area of the spacer such that a critical temperature, beyond which may lead to thermal runaway of a battery cell adjacent to the spacer, is not exceeded.

The first lateral surface of the battery cell is opposite to the second lateral surface of the battery cell such that a spacer contacts and thermally separates the first lateral surface of a first battery cell and the second lateral surface of a second battery cell.

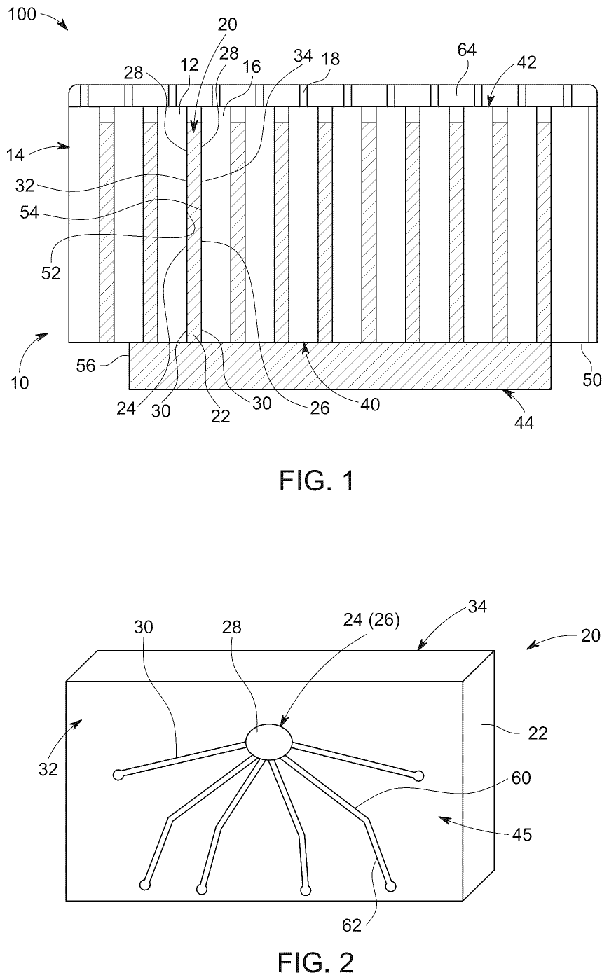

FIG. 1 is a schematic cross-sectional view of a battery system 100 according to an embodiment of the present disclosure. The battery system 100 includes a battery pack 10 including a housing 50 accommodating a plurality of battery cells 12, 16 and at least one spacer 20 arranged between two adjacent ones of the battery cells 12, 16. In the illustrated embodiment, the battery cells 12, 16 and the spacers 20 are alternately arranged to form a battery cell stack 14 within the housing 50. The battery pack 10 further includes a cooler 44 connected to (or arranged at) a cooling side 40 of the battery pack 10. In the illustrated embodiment, the cooling side 40 is a bottom side of the battery pack 10. Each of the battery cells 12, 16 includes a venting valve 18 orientated (or facing) away from the cooling side 40 and towards a venting side 42 of the battery pack 10 opposite to the cooling side 40. The venting valve 18 is positioned at (or in) a cover plate (e.g., a cap plate) 64 that seals a case enclosing (e.g., forming an outer structure of) the battery cells 12, 16. The cooler 44 includes a cooling plate 56 configured to allow a coolant to flow therethrough to dissipate heat from the battery cells 12, 16 of the battery cell stack 14. The battery cell stack 14 is arranged on the cooling plate 56. The spacer 20 includes a thermally insulating core 22 made of a material with relatively low thermal conductivity, such as a polymer or a hard foam.

Two heat conductive structures 24, 26 are arranged on or near the opposite lateral surfaces 32, 34 of each spacer 20. A first lateral surface 32 of the spacer 20 faces a first lateral surface 52 of a first battery cell 12, and a second lateral surface 34 of the spacer 20, opposite to the first lateral surface 32 of the spacer 20, faces a second lateral surface 54 of a second battery cell 16, opposite to the first lateral surface 52 of the first battery cell 12.

FIG. 2 is a perspective view of an embodiment of a spacer 20 for the battery pack 10. The spacer 20 has a thermally insulating core 22 and two heat conductive structures 24, 26 arranged on or near opposite lateral surfaces 32, 34 thereof. In the embodiment shown in FIG. 2, the heat conductive structures 24, 26 are disposed on the lateral surfaces 32, 34, respectively. The heat conductive structures 24, 26 include a thermally high conductive center element 28 covering (or aligned with) an expected heat hotspot of the battery cell 12 when the battery cell 12 heats up due to, for example, a malfunction. There are a plurality of trajectories (or projections) 30 that extend from the thermally high conductive center element 28 into the peripheral areas of the spacer 20 to improve heat transfer and to achieve a more even heat distribution throughout the spacer 20. Thus, the heat conductive structure 24, 26 may be designed in a radial structure 45. The center element 28 and the trajectories 30 are made of a thermally high conductive material, such as copper or aluminum. As shown in FIG. 2, the heat conductive structure 24, 26 includes six trajectories 30 extending from the thermally high conductive center element 28 into the lower peripheral area of the spacer 20 to transfer heat to the cooling side of the battery pack 10. Some trajectories 30 may have a first portion 60 extending from the thermally high conductive center element 28 and a second portion 62 extending at an angle with respect to the first portion 60 to provide more uniform coverage of the lateral surface 32, 34 of the spacer 20. The heat conductive structure 24, 26 structure may further include another set of trajectories 30 that extend from the center element 28 into the upper peripheral area of the spacer 20 to further improve (e.g., to further equalize) heat distribution on the lateral surface of the spacer 20. The heat conductive structure 24, 26 can be produced easily and inexpensively, for example, as a stamped part or as a fine blanked part. In another embodiment, the heat conductive structure 24, 26 may be designed in a star structure, with the trajectories 30 extending from the center element 28 into the peripheral areas of the spacer 20 and having a same distance between each trajectory 30.

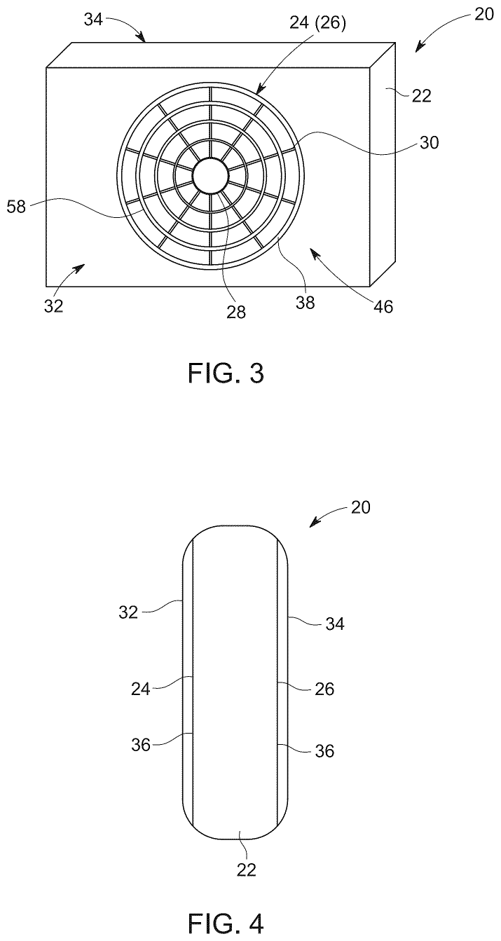

FIG. 3 shows a spacer 20 according to another embodiment of the present disclosure. The spacer 20 has a thermally insulating core 22 and two heat conductive structures 24, 26 arranged on or near opposite lateral surfaces 32, 34 thereof. The heat conductive structures 24, 26 are designed in a spider web structure 46, having a thermally high conductive center element 28 covering (or aligned with) an expected hotspot of the battery cell 12, which may arise when the battery cell 12 heats up due to, for example, a malfunction. The spider web structure 46 includes a plurality of trajectories 30 extending from the center element 28 into the peripheral areas of the spacer 20 and circular structures 58 connecting (e.g., extending between) the trajectories 30 so that heat can be additionally conducted along the circular structures 58. The center element 28, the circular structures 58, and the trajectories 30 are made of a thermally high conductive material, such as copper or aluminum. The heat conductive structure 24, 26 can be produced easily and inexpensively, for example, as a stamped part or as a fine blanked part. The spider web structure 46 allows for improved heat transfer on the lateral surface 32, 34 of the spacer 20 to achieve more even heat distribution in (or across) the spacer 20.

FIG. 4 is a cross-sectional view of a spacer 20 according to another embodiment. The spacer 20 includes a thermally insulating core 22 and two heat conductive structures 24, 26 formed of a thermally high conductive material, such as copper or aluminum, embedded within the thermally insulating core 22. The heat conductive structures 24, 26 are formed as stamped metal plates 36 partly or fully embedded in the thermally insulating core 22 of the spacer 20. The heat conductive structures 24, 26 may be designed as described above and designed in a radial structure, a star structure, a spider web structure, or other suitable structure. The distance from the first lateral surface 32 to the first heat conductive structure 24 is in a range between about 1% and about 10% and, in some embodiments, is in a range between about 2% and about 5%, of the overall thickness of the spacer 20. The distance from the second lateral surface 34 to the second heat conductive structure 26 is in a range between about 1% and about 10% and, in some embodiments is in a range of between about 2% and about 5%, of the overall thickness of the spacer 20.

The gap between the first heat conductive structure 24 and the second heat conductive structure 26 is greater than about 80% of the total thickness of the spacer 20.

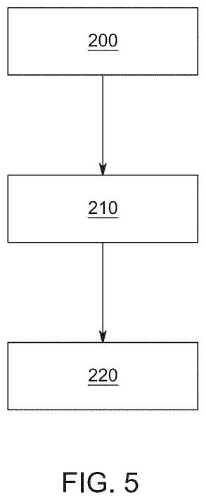

FIG. 5 is a flowchart describing a process for transferring heat from a battery cell 12, which heating up due to, for example, a malfunction according to an embodiment of the present disclosure. A heated battery cell 12 is a battery cell whose temperature is far above the normal operating temperature or in which a thermal runaway is already taking place. In a first step <200>, a battery pack 10 as described above is provided. In a second step <210>, the battery cells 12, 16 of the battery cell stack 14 are separated from each other by positioning a spacer 20 between the first battery cell 12 and the second battery cell 16 such that a first lateral surface 32 of the spacer 20 contacts a first lateral surface 52 of the first battery cell 12 and a second lateral surface 34 of the spacer 20, opposite to the first lateral surface 32, contacts a second lateral surface 54 of a second battery cell 16 of the battery cell stack. In a third step <220>, heat from a heated (or hot) battery cell 12 of the battery cell stacks 14 is transferred via the spacer 20. In more detail, the heat is transferred from a heat hotspot on a lateral surface 52, 54 of the affected battery cell 12 to the center element 28 of the spacer 20 and then transferred to the peripheral areas of the spacer 20 such that a critical temperature, which may lead to a thermal runaway of a battery cell 16 adjacent to the heated battery cell 12, is not exceeded.

### SOME REFERENCE NUMERALS

10 battery pack 12 first battery cell
14 battery cell stack 16 second battery cell
18 venting valve
20 spacer 22 thermally insulating core
24 first heat conductive structure
26 second heat conductive structure
28 center element
30 trajectories 32 first lateral surface
34 second lateral surface 36 stamped metal plate
40 cooling side/bottom side 42 venting side
44 cooler 45 radial structure
46 spider web structure
50 housing
52 first lateral surface of the battery cell
54 second lateral surface of the battery cell
56 cooling plate 58 circular structure
60 first portion 62 second portion
64 cover plate
100 battery system

1 what is claimed is:

1. A battery pack comprising:
a battery cell stack comprising a plurality of battery cells and a spacer between two adjacent ones of battery cells; and
a cooler at a bottom side of the battery cell stack, the bottom side of the battery cell stack being opposite to a venting side of the battery cell stack,
wherein the spacer comprises a thermally insulating core and a heat conductive structure at a lateral surface of the spacer facing a lateral surface of one of the battery cells,
wherein the heat conductive structure comprises a center element arranged centrally in the lateral surface of the spacer and trajectories extending from the center element into peripheral areas of the lateral surface of the spacer.

2. The battery pack as claimed in claim 1, wherein the spacer comprises two heat conductive structures respectively arranged at opposite lateral surfaces of the spacer.

3. The battery pack as claimed in to claim 1, wherein the heat conductive structure has a thermal conductivity at least one hundred times higher than a thermal conductivity of the thermally insulating core.

4. The battery pack as claimed in claim 1, wherein the heat conductive structure is made of metal.

5. The battery pack as claimed in claim 4, wherein the metal is aluminum or copper.

6. The battery pack as claimed in claim 1, wherein the heat conductive structure comprises a stamped metal plate of a high thermal conductive material.

7. The battery pack as claimed in claim 1, wherein the heat conductive structure comprises:
a thermally highly conductive center element;
a first set of thermally high conductive trajectories extending from the center element into an upper peripheral area of the spacer; and
a second set of thermally highly conductive trajectories extending from the center element into a lower peripheral area of the spacer.

8. The battery pack as claimed in claim 1, wherein the heat conductive structure has a radial structure.

9. The battery pack as claimed in claim 1, wherein the heat conductive structure has a star structure,
wherein the trajectories extend from the center element into a peripheral area of the spacer and have a same distance between each adjacent one of the trajectories.

10. The battery pack as claimed in claim 1, wherein the heat conductive structure has a spider web structure,
wherein the spider web structure comprises the trajectories extending from the center element into a peripheral area of the spacer and circular structures connecting adjacent ones of the trajectories.

11. The battery pack as claimed in claim 1, wherein the heat conductive structure is embedded in the thermally insulating core.

12. The battery pack as claimed in claim 1, wherein the battery cells are prismatic battery cells.

13. A battery system comprising the battery pack as claimed in claim 1.

14. A method for transferring heat within the battery pack as claimed in claim 1, the method comprising transferring heat from a heated up battery cell of the battery cell stack via the spacer from a hotspot of the battery cell to a peripheral area of the spacer.
